(19) United States
(12) Patent Application Publication
(10) Pub. No.: US 2025/0262913 A1
(43) Pub. Date: Aug. 21, 2025

(54) RANKINE CYCLE SYSTEM, RANKINE-REFRIGERATION CYCLE SYSTEM AND REFRIGERATED VEHICLE

(71) Applicant: ZHEJIANG ASCENRISE HEAT PUMP CO., LTD., Lanxi City (CN)

(72) Inventor: Kaijian WANG, Lanxi City (CN)

(73) Assignee: ZHEJIANG ASCENRISE HEAT PUMP CO., LTD., Lanxi City (CN)

(21) Appl. No.: 18/861,350

(22) PCT Filed: Apr. 29, 2022
(86) PCT No.: PCT/CN2022/090526

§ 371 Date: Oct. 29, 2024

(51) Int. Cl. B60H 1/32

(52) U.S. Cl. CPC B60H 1/323; B60H 1/3222; B60H 1/3227; B60H 1/3229; B60H 2001/3254; B60H 2001/3264; B60H 2001/3288; B60H 2001/3289

(57) ABSTRACT

A rankine cycle system (1), a rankine-refrigeration cycle system (2) and a refrigerated vehicle are disclosed. The rankine cycle system (1) comprises a first evaporator (11), an expander (12), a condenser (13) and a refrigerant pump (14) connected in sequence to form a cycle, wherein the rankine cycle system (1) further comprises an electric heating device (15) connected between the refrigerant pump (14) and the expander (12) for heating the refrigerant. When the rankine cycle system (1) has no waste heat source, the present application can continue to provide energy to the rankine cycle through the electric heating device (15), thereby enabling the expander (12) to continuously and effectively output mechanical work. Even without a waste heat source, the rankine cycle can still operate normally, thus adapting to more operating conditions.

### TECHNICAL FIELD

The present application relates to a rankine cycle system, a rankine-refrigeration cycle system and a refrigerated vehicle, and more particularly to a rankine cycle system, a rankine-refrigeration cycle system and a refrigerated vehicle adaptable to more operating conditions.

### BACKGROUND

In existing rankine cycle systems, rankine-refrigeration cycle systems and refrigerated vehicles, an organic rankine cycle system converts waste heat energy into mechanical work, and transfers the mechanical work output from the expander of the organic rankine cycle system to the compressor in the refrigeration cycle system through a transmission assembly, thereby achieving heat-driven operation of the refrigeration cycle system; or transfers the mechanical work output from the expander to other devices for other purposes.

However, when the refrigerated vehicle is not started, waste heat cannot be generated, which prevents sufficient evaporation of the refrigerant, and consequently prevents normal and stable operation of the expander, leading to unstable operation of the compressor, and ultimately causing the refrigeration cycle system to fail to provide effective cooling.

### SUMMARY

An object of the present application is to provide a rankine cycle system, a rankine-refrigeration cycle system and a refrigerated vehicle that are adaptable to more operating conditions.

To achieve the above object, the present application adopts the following technical solutions:

A rankine cycle system comprises a first evaporator, an expander, a condenser and a refrigerant pump connected in sequence to form a cycle, wherein the rankine cycle system further comprises at least two heating modes for providing heat to the first evaporator.

Furthermore, the heating modes comprise waste heat heating, electric heating, combustion heating, geothermal heating, or residual heat heating.

Furthermore, the rankine cycle system further comprises a heating device connected between the refrigerant pump and the expander for heating the refrigerant; wherein:
the heating device is an electromagnetic induction heating device comprising an electromagnetic heating controller and an electromagnetic induction coil connected to the electromagnetic heating controller, wherein the electromagnetic induction coil is fitted around an outer side of a pipeline between the first evaporator and the expander;
or, the heating device is a combustion heating device or a thermal radiation device.

Furthermore, the rankine cycle system further comprises a detection device disposed between the heating device and the expander for detecting temperature and/or pressure of the refrigerant.

Furthermore, the refrigerant pump is a variable-frequency refrigerant pump.

A rankine-refrigeration cycle system, comprising a refrigeration cycle system and the rankine cycle system according to claim 1, wherein the refrigeration cycle system comprises a compressor, a first heat exchanger, a throttling device and a second evaporator connected in sequence to form a cycle, and wherein the rankine-refrigeration cycle system further comprises a transmission assembly connecting the expander and the compressor.

Furthermore, wherein the first heat exchanger comprises a first fluid passage and a second fluid passage, wherein the first fluid passage is connected between the compressor and the throttling device, and the second fluid passage is connected between the refrigerant pump and the first evaporator; wherein the rankine-refrigeration cycle system further comprises a second heat exchanger having a first fluid passage and a second fluid passage, wherein the first fluid passage is connected between the second evaporator and the compressor, and the second fluid passage is connected between the expander and the condenser.

8. The rankine-refrigeration cycle system according to claim 6, wherein the compressor has a first working state in which it is connected to the expander through the transmission assembly, and a second working state in which it is connected to an electric drive mechanism.

Furthermore, wherein the transmission assembly comprises a main drive shaft connected to the expander and a secondary drive shaft connected to the compressor, wherein the main drive shaft and the secondary drive shaft are detachably connected; wherein the electric drive mechanism comprises a first clutch disposed on the secondary drive shaft, a drive motor cooperating with the first clutch, and a connecting structure connecting the first clutch and the drive motor.

Furthermore, wherein the transmission assembly further comprises a connecting device for connecting the main drive shaft and the secondary drive shaft, wherein the connecting device comprises a coupling fixed to one of the main drive shaft and the secondary drive shaft, and a second clutch cooperating with and fixed to the coupling on the other shaft;
or, wherein the transmission assembly further comprises a connecting device for connecting the main drive shaft and the secondary drive shaft, wherein the connecting device comprises a coupling fixed to one of the main drive shaft and the secondary drive shaft, and a second clutch cooperating with and fixed to the coupling on the other shaft, wherein the connecting device comprises a first gear disposed on the main drive shaft and a second gear disposed on the secondary drive shaft and cooperating with the first gear, wherein the first gear and the second gear have different diameters;
or, wherein the transmission assembly further comprises a connecting device for connecting the main drive shaft and the secondary drive shaft, wherein the connecting device comprises a coupling fixed to one of the main drive shaft and the secondary drive shaft, and a second clutch cooperating with and fixed to the coupling on the other shaft, wherein the connecting device comprises a first gear disposed on the main drive shaft, a second clutch fixed to the first gear, and a second gear disposed on the secondary drive shaft and cooperating with the first gear, wherein the first gear and the second gear have different diameters, and wherein the first gear drives the main drive shaft to rotate through the second clutch.

Furthermore, wherein the first clutch is an electrically-engaged clutch, and the second clutch is an electrically-disengaged clutch.

Furthermore, wherein the electric drive mechanism further comprises a power supply module for supplying power to the first clutch, the second clutch and the drive motor.

Furthermore, wherein the rankine-refrigeration cycle system further comprises a subcooling degree controller connected between the first heat exchanger and the throttling device.

A refrigerated vehicle comprising a refrigerated chamber, and further comprising the rankine-refrigeration cycle system according to claim 6, wherein the first evaporator of the rankine cycle system is thermally connected to a waste heat source of the refrigerated vehicle through a heat transfer assembly, and wherein the evaporator of the refrigeration system supplies cooling to the refrigerated chamber through a cooling assembly.

Furthermore, wherein the refrigerated vehicle comprises an engine and a heat dissipation assembly for cooling the engine, wherein the heat transfer assembly connects the heat dissipation assembly and the first evaporator; or, wherein the refrigerated vehicle further comprises a cold storage unit for providing cooling capacity to the refrigerated chamber, wherein the second evaporator is thermally connected to the cold storage unit.

Advantageous effects of the present application: The rankine cycle system of the present application includes an electric heating device disposed between the refrigerant pump and the expander, which can continue to provide energy to the rankine cycle through the electric heating device in the absence of a waste heat source, thereby enabling the expander to continuously and effectively output mechanical work. Even without a waste heat source, the rankine cycle can still operate normally, thus adapting to more operating conditions.

### BRIEF DESCRIPTION OF THE DRAWINGS

FIG. 1 is a schematic diagram of the rankine-refrigeration cycle system according to the present application.

FIG. 2 is a perspective view of a first embodiment of the expander and compressor according to the present application.

FIG. 3 is an exploded perspective view of FIG. 1.

FIG. 4 is a perspective view of a second embodiment of the expander and compressor according to the present application.

FIG. 5 is an exploded perspective view of FIG. 4.

FIG. 6 is a perspective view of a third embodiment of the expander and compressor according to the present application.

### DETAILED DESCRIPTION

The present application will be described in detail with reference to the embodiments shown in the accompanying drawings. However, these embodiments do not limit the present application, and any structural, methodological, or functional modifications made by those skilled in the art based on these embodiments fall within the protection scope of the present application.

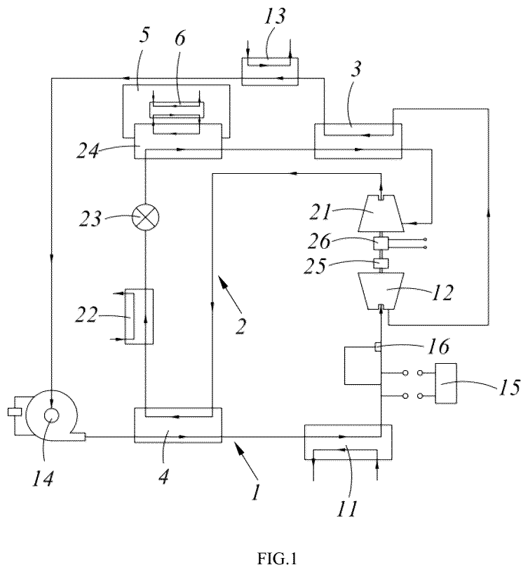

Referring to FIGS. 1 to 6, an embodiment of the rankine cycle system according to the present application is shown. The rankine cycle system 1 comprises a first evaporator 11, an expander 12, a condenser 13, and a refrigerant pump 14 connected in sequence to form a cycle. The rankine cycle system 1 further comprises a heating device 15 connected between the refrigerant pump 14 and the expander 12 for heating the refrigerant. During the initial operating phase of the rankine cycle, stable operation can be achieved, thereby effectively outputting mechanical work while preventing liquid refrigerant from entering the expander 12.

In this embodiment, as shown in FIG. 1, the rankine cycle system 1 is an organic rankine cycle system, primarily used for converting waste heat energy (waste heat) into mechanical work. The expander 12 can be connected to other devices, such as generators, compressor 21, etc., through a transmission device, thereby converting the mechanical work of the expander 12 into a power source for other devices, thus obtaining electrical energy or other forms of energy to meet corresponding needs.

Specifically, as shown in FIGS. 1 to 5, the refrigerant pump 14 is connected to the first evaporator 11 to form a cycle. The refrigerant is evaporated by absorbing waste heat energy through the first evaporator 11, then enters the expander 12 to perform work. The refrigerant flows from the expander 12 to the condenser 13 for heat release, and is then pressurized by the refrigerant pump 14 and driven into the first evaporator 11, thus completing the cycle.

In this embodiment, the heating device 15 is an electromagnetic induction heating device, which is both readily available and easy to install. Specifically, the electromagnetic induction heating device comprises an electromagnetic heating controller and an electromagnetic induction coil connected to the electromagnetic heating controller, wherein the electromagnetic induction coil is fitted around the outer side of the pipeline between the first evaporator 11 and the expander 12. Of course, the electric heating method is not limited to the electromagnetic induction heating device.

When the electromagnetic induction heating device operates, alternating current generated after power-on produces an alternating magnetic field through the electromagnetic induction coil. The pipeline placed within cuts the alternating magnetic flux lines, thereby generating alternating current (i.e., eddy currents) inside the material. The eddy currents cause high-speed random motion of atoms inside the material, and the atoms collide and friction with each other to generate thermal energy, thus achieving the heating effect.

The present application also provides alternative heating devices 15, for example: the heating device 15 may be a combustion heating device or a thermal radiation device. The combustion heating device generates heat by burning fossil fuels, biofuels, or other combustible substances. The thermal radiation device transfers heat from the high-temperature side to the refrigerant through heat conduction for heat exchange and refrigerant heating, for example: heating the refrigerant through heat exchange with waste heat, residual heat, biological heat, geothermal heat, or other heat sources.

Of course, in other embodiments, the heating device 15 may be other devices, as long as they can heat the refrigerant in the pipeline between the first evaporator 11 and the expander 12.

Moreover, the rankine cycle system 1 includes at least two heating modes for providing heat to the first evaporator 11. Specifically, the heating modes may include waste heat heating, electric heating, combustion heating, geothermal heating, or residual heat heating, among other heating modes, and are not limited to the aforementioned modes, as long as they can provide heat to the first evaporator 11.

The rankine cycle system 1 also includes a detection device 16 disposed between the heating device 15 and the expander 12 for detecting the temperature and/or pressure of the refrigerant. The detection device 16 can detect whether the refrigerant has fully evaporated. In this embodiment, the detection device 16 is a temperature sensor located between the first evaporator 11 and the expander 12 for detecting the temperature at the outlet of the first evaporator 11 or the inlet of the expander 12, determining whether the refrigerant has fully evaporated by monitoring its temperature when leaving the first evaporator 11 or before entering the expander 12. This allows timely and effective determination of whether heating is needed and the heating duration based on the refrigerant state, thereby reducing the risk of incompletely evaporated refrigerant entering the expander 12 and causing operational failure, thus ensuring stable operation of the expander 12.

In this embodiment, since the piping of the rankine cycle system 1 is typically made of copper, which has good thermal conductivity, the surface temperature of the copper can represent the refrigerant temperature. Therefore, the temperature sensor only needs to measure the surface temperature of the pipeline, making the temperature sensor installation very convenient, as it only needs to be mounted on the pipeline to measure the surface temperature.

Of course, in other embodiments, the temperature sensor may be integrated with the electromagnetic induction heating device. The detection device 16 may also be a pressure sensor, although pressure sensors need to be installed inside the pipeline, making their installation more challenging compared to temperature sensors.

During the initial operating phase of the rankine cycle, when the energy from the waste heat source is unstable, the refrigerant can be heated through the heating device 15 to ensure complete evaporation. In alternative embodiments, a valve may be installed on the pipeline downstream of the first evaporator 11, which remains closed until the first evaporator 11 has absorbed sufficient heat to fully evaporate the refrigerant, thereby ensuring stable operation of the expander 12.

The refrigeration cycle system 2 comprises a compressor 21, a first heat exchanger 4, a throttling device 23, and a second evaporator 24 connected in sequence to form a cycle.

Furthermore, the refrigeration cycle system 2 includes a subcooling degree controller 22, which can further adjust the subcooling degree of the refrigerant in the refrigeration cycle to meet specific requirements.

In this embodiment, due to the presence of the first heat exchanger 4, the subcooling degree controller 22 functions differently from condensers in conventional refrigeration systems. In conventional refrigeration systems, the condenser converts high-temperature, high-pressure gaseous refrigerant from the compressor into liquid refrigerant through phase change. However, in this embodiment, the high-temperature, high-pressure refrigerant from the compressor 21 first passes through the first heat exchanger 4, where it thermally couples part of its heat to the refrigerant in the rankine cycle. Since the refrigerant flow rate in the rankine cycle is greater than that in the refrigeration cycle, the refrigerant in the refrigeration cycle undergoes the gas-to-liquid phase change process in the first heat exchanger 4. Therefore, the subcooling degree controller 22 merely adjusts the subcooling degree of the refrigeration cycle refrigerant without involving any phase change process.

In this embodiment, different refrigerants are used in the rankine cycle system 1 and the refrigeration cycle system. The refrigerants used in the rankine cycle system 1 may include: R245fa, R134a, R123, and R1233zd, while the refrigerants used in the refrigeration cycle system 2 may include: R134a, R404A, R448A, R455A, and R32.

This differentiation is determined by the inherent characteristics of the systems. For example, the refrigerant evaporation temperature in the refrigeration cycle system 2 is relatively low, typically several tens of degrees below zero. If such refrigerant were used in the rankine cycle, it would already be in a gaseous state at room temperature, and with additional waste heat energy, the pressure would increase dramatically, potentially causing pipeline rupture in the rankine cycle. Moreover, using higher-strength materials to prevent pipeline rupture would increase costs. Conversely, the refrigerant evaporation temperature in the rankine cycle system 1 is relatively high, typically around or above zero degrees. If this refrigerant were used in the refrigeration cycle, it would not readily evaporate, resulting in ineffective cooling.

To fully utilize the waste heat generated in both the rankine cycle and refrigeration cycle processes while reducing environmental impact, the pipeline between the refrigerant pump 14 and the first evaporator 11 is thermally connected to the first heat exchanger 4, and the pipeline between the expander 12 and condenser 13 is thermally connected to the pipeline between the second evaporator 24 and compressor 21. In this embodiment, the thermal connection between the expander 12-condenser 13 pipeline and the second evaporator 24-compressor 21 pipeline is achieved through the second heat exchanger 3. In alternative embodiments, other connection structures may be used, such as heat pipes.

The first heat exchanger 4 comprises a first fluid passage and a second fluid passage. The first fluid passage is connected between the compressor 21 and the throttling device 23, while the second fluid passage is connected between the refrigerant pump 14 and the first evaporator 11. In this embodiment, the first fluid passage is connected between the compressor 21 and the subcooling degree controller 22.

The second heat exchanger 3 comprises a first fluid passage and a second fluid passage. The first fluid passage is connected between the second evaporator 24 and the compressor 21, while the second fluid passage is connected between the expander 12 and the condenser 13. The refrigerant in the first fluid passages of both the first heat exchanger 4 and the second heat exchanger 3 is the refrigeration cycle system 2 refrigerant, while the refrigerant in the second fluid passages of both heat exchangers is the rankine cycle system 1 refrigerant.

First, the first heat exchanger 4 is used to cool the refrigerant flowing from the compressor 21, wherein the refrigerant undergoes a heat release process in the first heat exchanger 4. The first heat exchanger 4 collects the heat released by the refrigerant. In the rankine cycle system 1, this heat can be used to heat the medium-temperature, medium-pressure refrigerant flowing from the refrigerant pump 14. This arrangement serves multiple purposes: it increases the temperature and pressure of the refrigerant, enhances the internal energy of the refrigerant entering the first evaporator 11, compensates for insufficient heat when the low-grade heat source is unstable, and in the refrigeration cycle system 2, reduces the temperature of the refrigerant entering the subcooling degree controller 22, thereby reducing the thermal load on the subcooling degree controller 22.

Second, the second heat exchanger 3 is used to cool the refrigerant flowing from the expander 12, where the refrigerant also undergoes a heat release process. The second heat exchanger 3 collects the heat released by the refrigerant. In the rankine cycle process, this arrangement reduces the refrigerant temperature at the expander 12 outlet and decreases the thermal load on the condenser 13. In the refrigeration cycle system 2, this heat can be used to heat the low-temperature, low-pressure refrigerant flowing from the second evaporator 24, providing it with a certain degree of superheat, thereby ensuring complete evaporation into gaseous state and reducing the risk of liquid hammer in the compressor 21, thus enhancing the compressor's reliability.

The first heat exchanger 4 and second heat exchanger 3 significantly improve the operational reliability of both the rankine cycle system 1 and refrigeration cycle system 2. The waste heat generated by both systems can be mutually utilized, improving waste heat utilization efficiency. This arrangement reduces both the thermal load on the condenser 13 and subcooling degree controller 22, and minimizes the environmental impact of waste heat while reducing the energy consumption of additional devices required for heat load absorption.

The present application also provides a waste heat recovery device (not shown), which is a heat exchanger connecting the pipeline between the expander 12 and condenser 13 with the pipeline between the refrigerant pump 14 and first evaporator 11. Specifically, this heat exchanger connects these two pipelines and primarily functions to cool the refrigerant flowing from the expander 12.

During the rankine cycle process, this arrangement reduces the refrigerant temperature at the expander 12 outlet and decreases the thermal load on the condenser 13, while simultaneously using the recovered heat to heat the medium-temperature, medium-pressure refrigerant flowing from the refrigerant pump 14. This configuration increases the refrigerant's temperature and pressure, enhances the internal energy of the refrigerant entering the first evaporator 11, and compensates for insufficient heat when the low-grade heat source is unstable.

The refrigeration cycle system 2 of the rankine-refrigeration cycle system further includes a transmission assembly 25 connecting the expander 12 and compressor 21. The transmission assembly 25 includes a drive shaft 251 connecting the expander 12 and compressor 21. Consequently, the mechanical work generated by the expander 12 can directly serve as the power source for the compressor 21, maximizing energy efficiency, reducing energy loss, and improving cooling effectiveness. Moreover, the direct connection between the expander 12 and compressor 21 via drive shaft 251 makes the rankine-refrigeration cycle system more compact, reducing the overall system footprint. In this embodiment, the drive shaft 251 has a split structure, though in other embodiments, it may have an integral structure.

To ensure normal operation of the refrigeration cycle system 2 when there is no waste heat energy supply to the rankine cycle, i.e., when the refrigeration cycle loses its power source, the rankine-refrigeration cycle system of the present application includes an electric drive mechanism 26 mounted on the transmission assembly 25 to drive the compressor 21. In this embodiment, the electric drive mechanism 26 refers to a device that converts electrical energy into mechanical energy.

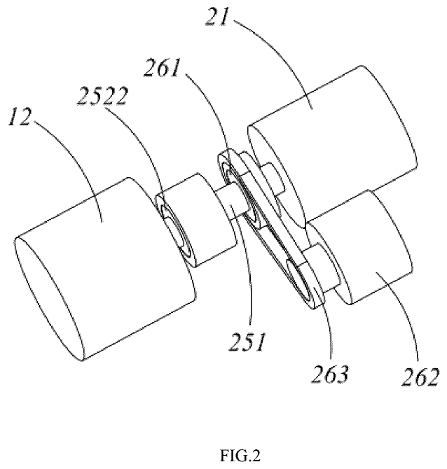

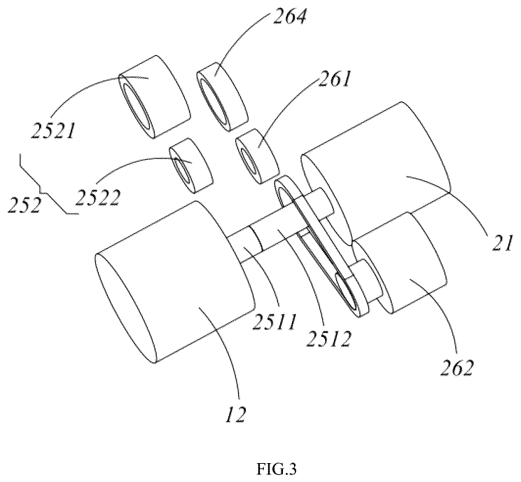

As shown in FIGS. 2 and 3, the electric drive mechanism 26 comprises a first clutch 261 mounted on the drive shaft 251, a drive motor 262 cooperating with the first clutch 261, and a connecting structure 263 connecting the first clutch 261 and the drive motor 262. The connecting structure 263 may comprise two cooperating gears, with the first clutch 261 fixed to the gear on the drive shaft 251. Alternatively, the two gears may be connected by a chain. Thus, when the electric drive mechanism 26 is connected to an external power source, it can directly operate the compressor 21, enabling normal operation of the refrigeration cycle system 2. The electric drive mechanism 26 may also include its own power supply module (not shown).

To facilitate normal operation of the first clutch 261, the electric drive mechanism 26 further includes a mating structure 264 fixed to the first clutch 261. The mating structure 264 may be connected to the drive motor 262 through structures such as chains or belts. To prevent interference from the first clutch 261 when the rankine cycle provides power to the refrigeration cycle, the mating structure 264 can be fixed in a corresponding position. Therefore, when the first clutch 261 is not operating, it will not interfere with the drive shaft 251.

Specifically, in this embodiment, the drive shaft 251 comprises a main drive shaft 2511 and a secondary drive shaft 2512 that can be connected to and separated from each other. The main drive shaft 2511 is connected to the expander 12, while the secondary drive shaft 2512 is connected to the compressor 21. The secondary drive shaft 2512 may be either the compressor's 21 own shaft or another structure connected to the compressor's 21 shaft. The transmission assembly 25 further includes a connecting device 252 for rigidly connecting the main drive shaft 2511 and the secondary drive shaft 2512.

When the refrigeration cycle system 2 needs to operate, the connecting device 252 can be controlled to rigidly connect the main drive shaft 2511 and the secondary drive shaft 2512. When the expander 12 performs work, the compressor 21 operates accordingly. When the refrigeration cycle system 2 is not required to operate, the connecting device 252 is controlled to disengage, allowing the expander 12 to perform work independently without affecting the compressor 21.

In this embodiment, the connecting device 252 comprises a coupling 2521 fixed to either the main drive shaft 2511 or the secondary drive shaft 2512, and a second clutch 2522 that cooperates with and is fixed to the coupling 2521 on the other shaft. Specifically, when the coupling 2521 is fixed to the main drive shaft 2511, the second clutch 2522 is used to secure the secondary drive shaft 2512, and when the coupling 2521 is fixed to the secondary drive shaft 2512, the second clutch 2522 is used to secure the main drive shaft 2511.

Of course, in other embodiments, the drive shaft 251 may also be an integral structure directly connecting the expander 12 and compressor 21, meaning the expander 12 and compressor 21 always operate or stop simultaneously, thus eliminating the need for the connecting device 252.

In this embodiment, the first clutch 261 is mounted on the secondary drive shaft 2512. When the rankine cycle system 1 cannot provide power to the refrigeration cycle system 2, the connecting device 252 can be controlled to disengage the main drive shaft 2511 from the secondary drive shaft 2512, separating the two shafts. Then, the first clutch 261 is controlled to secure the secondary drive shaft 2512, and the drive motor 262 drives the first clutch 261 and secondary drive shaft 2512 to rotate, ultimately enabling normal operation of the compressor 21.

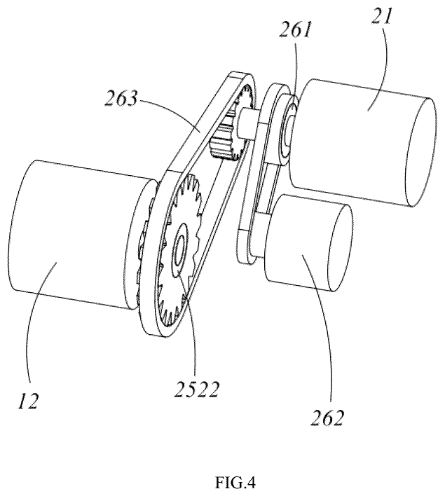

As shown in FIGS. 4 to 6, the present application provides alternative embodiments of the connecting device 252. The connecting device 252 comprises a first gear 2523 mounted on the main drive shaft 2511 and a second gear 2524 mounted on the secondary drive shaft 2512 that meshes with the first gear 2523, wherein the first gear 2523 and the second gear 2524 have different diameters. The second clutch 2522 is fixed to the first gear 2523, and the first gear 2523 drives the main drive shaft 2511 to rotate through the second clutch 2522.

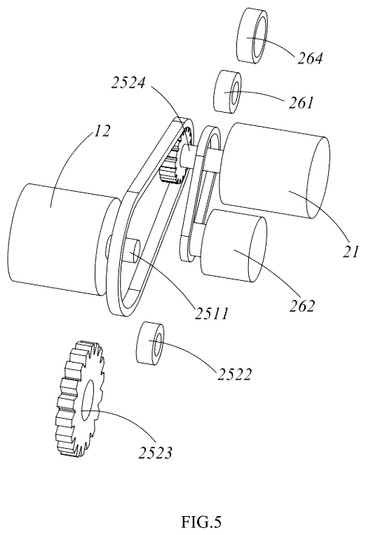

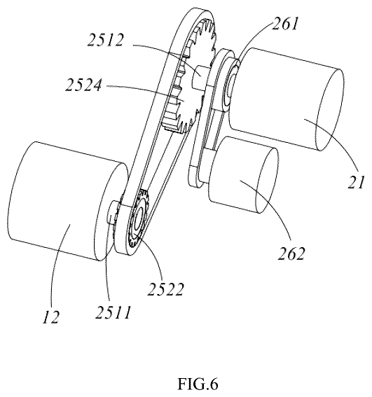

The first gear 2523 and second gear 2524 may either directly mesh with each other or be connected through structures such as chains. As shown in FIGS. 4 and 5, which illustrate the second embodiment of the connecting device 252, when the diameter of the first gear 2523 is larger than that of the second gear 2524, it produces an acceleration effect. As shown in FIG. 6, which illustrates the third embodiment of the connecting device 252, when the diameter of the second gear 2524 is smaller than that of the first gear 2523, it produces a deceleration effect.

Therefore, different connecting devices 252 can be selected according to actual conditions. Alternatively, a transmission can be chosen to freely adjust speed, thereby regulating the compressor 21 rotation speed and consequently adjusting cooling efficiency. Moreover, when the torque on the secondary drive shaft 2512 of the compressor 21 is high, deceleration can be used to prevent damage to the compressor 21.

In this embodiment, both the first clutch 261 and second clutch 2522 are electromagnetic clutches. Specifically, the first clutch 261 is an electrically-engaged clutch, and the second clutch 2522 is an electrically-disengaged clutch, meaning that the first clutch 261 engages with the secondary drive shaft 2512 only when energized, while the second clutch 2522 engages with the main drive shaft 2511 only when de-energized. Consequently, the first clutch 261 and second clutch 2522 can either share an external power source or be powered uniformly through the power supply module of the electric drive mechanism 26, making control very simple. Of course, the first clutch 261 and second clutch 2522 can also be powered by different power sources, i.e., non-uniform power supply.

Specific operating process: When the rankine cycle operates normally, no power supply is needed, and the expander 12 can directly drive the compressor 21. When the rankine cycle cannot operate normally, power is supplied to the first clutch 261, second clutch 2522, and electric drive mechanism 26. At this point, the first clutch 261 engages with the secondary drive shaft 2512, the second clutch 2522 disengages from the main drive shaft 2511, allowing the drive motor 262 to drive the compressor 21 to rotate while the expander 12 remains stationary.

In addition to the above methods, when the rankine cycle system 1 has no waste heat source, the refrigerant can continue to be evaporated through the heating device 15, enabling continuous operation of the rankine cycle. This means the expander 12 can continuously and effectively output power. The heating device 15 serves as a representative heating method here and can be replaced by other heating methods, thus enabling normal operation of the rankine cycle and maintaining power output even in the absence of a waste heat source.

The inventors have found that existing refrigerated vehicles control the cooling capacity supplied to the refrigerated chamber through dampers in the refrigeration system 2. However, these dampers are electronic components with poor stability during transportation. In this embodiment, a variable-frequency refrigerant pump 14 is employed, which adjusts the refrigerant flow rate according to cooling capacity requirements to regulate the output power of the expander 12, thereby controlling the working power of the compressor 21 to achieve the purpose of adjusting cooling capacity.

Specifically, the variable-frequency refrigerant pump 14 can be appropriately adjusted within a certain range according to actual operating requirements, thereby improving the practicality of the rankine cycle system-refrigeration system. By adjusting the refrigerant flow rate in the rankine cycle, the amount of high-temperature, high-pressure refrigerant supplied to the expander 12 is regulated, thereby real-time adjusting the rotation speed of the expander 12 and consequently the compressor 21, ultimately achieving adjustable cooling effects.

Furthermore, the refrigerant pump 14 can determine how much refrigerant can be evaporated based on the current waste heat energy, and adjust its speed according to the amount of evaporated refrigerant, maintaining the entire system in an optimal operating state. On one hand, this fully utilizes the current waste heat energy, ensuring maximum refrigerant evaporation under the given waste heat energy conditions, thereby enabling the expander 12 to generate maximum mechanical work stably under these conditions. On the other hand, it prevents insufficient refrigerant evaporation caused by excessive flow rates, which could affect the stable operation of the expander 12.

Although the electric heating device 15 of the present application could be used to further heat the refrigerant when the flow rate is too high to ensure complete evaporation before entering the expander 12, this method consumes additional electrical energy and increases costs. Therefore, using the variable-frequency refrigerant pump 14 ensures that during subsequent cycles (non-initial operating phase), when waste heat energy is relatively stable, the electric heating device 15 is no longer needed, thereby saving electricity and reducing costs.

The rankine-refrigeration cycle system of the present application can also be applied to cold chain transportation equipment. In this embodiment, the rankine- refrigeration cycle system is applied to a refrigerated vehicle (not shown), which includes a vehicle body and a refrigerated chamber 5 mounted on the vehicle body. The refrigerated vehicle also includes the aforementioned rankine-refrigeration cycle system 2 for cooling the refrigerated chamber 5, and a heat transfer assembly connecting the vehicle's waste heat source to the first evaporator 11.

The refrigerated vehicle includes an engine and a heat dissipation assembly for cooling the engine. The heat dissipation assembly includes pipelines for coolant flow, and the heat transfer assembly connects these pipelines to the first evaporator 11. The heat transfer assembly can be either a heat transfer pipe (indirect connection) or a structure directly connecting the pipeline to the first evaporator 11 (direct connection). The coolant used is antifreeze.

During transportation, the engine generates substantial waste heat, which can be collected by the rankine-refrigeration cycle system 2 and converted into power for the refrigeration cycle to provide cooling to the refrigerated chamber 5, achieving power coupling by converting thermal energy into mechanical energy. This arrangement provides continuous cooling to the refrigerated chamber 5, ensuring refrigeration effectiveness while reducing waste heat emissions and environmental impact, and requires no electrical power from the vehicle itself, reducing energy consumption. Heat can also be extracted from the exhaust pipe. For example, waste heat source temperature of 100° C. can be converted to refrigerant temperature of −18° C., enabling the refrigerant to cool the refrigerated chamber 5. Generally, the energy of rankine cycle refrigerant above 30 kW complements the energy of refrigeration cycle with 3 kW cooling capacity.

The specific process is as follows:

First, after the high-temperature antifreeze exchanges heat with refrigerant in the first evaporator 11, the refrigerant vapor enters the expander 12, driving the scroll disk to rotate at high speed. Since the high-speed rotating scroll disk is coaxial with the compressor 21 main shaft, the expander 12 drives the compressor 21 to operate.

Second, after the compressor 21 compresses the refrigerant, the high-temperature, high-pressure refrigerant is discharged and enters the first heat exchanger 4, where it exchanges heat with the low-temperature refrigerant from the rankine cycle. The refrigerant in the refrigeration cycle condenses into liquid, releasing heat to preheat the low-temperature refrigerant in the rankine cycle, allowing the rankine cycle refrigerant to enter the first evaporator 11 at a relatively high temperature.

Third, the refrigeration cycle refrigerant enters the second evaporator 24, exchanges heat with the refrigerant there, then enters the second heat exchanger 3 to exchange heat with the refrigerant from the expander 12 outlet, ensuring the refrigeration cycle refrigerant has sufficient superheat before entering the compressor 21. Any rankine cycle refrigerant not sufficiently cooled in the second heat exchanger 3 continues to the condenser 13 for cooling until it reaches saturated liquid state, after which the refrigerant pump 14 pumps the liquid refrigerant into the first evaporator 11 to continue absorbing heat from the high-temperature antifreeze, completing the cycle.

In this embodiment, the refrigerated vehicle further includes a cold storage unit 6 configured to work with the refrigerated chamber 5, wherein the second evaporator 24 is connected to the cold storage unit 6 for cold charging. Therefore, when the temperature in the refrigerated chamber 5 is suitable and cooling is not required, the rankine-refrigeration cycle system 2 can still charge cooling capacity into the cold storage unit 6 for storage. When the temperature in the refrigerated chamber 5 rises, the cold storage unit 6 can release cooling capacity to lower the temperature, while the rankine-refrigeration cycle system 2 continues to charge the cold storage unit 6 to replenish cooling capacity. This arrangement effectively extends refrigeration time during long-distance transportation, ensuring the quality of transported goods and food materials.

When the refrigerated vehicle is operating, energy can be provided to the rankine cycle system 1 by absorbing waste heat. When the refrigerated vehicle stops operating, the electric heating device 15 can continue to be powered through mains electricity or backup power supply, ensuring continuous operation of the rankine cycle system 1 and consequently normal operation of the refrigeration cycle system 2, maintaining the temperature in the refrigerated chamber 5 at a low level and preserving the freshness of transported products.

Since the refrigerated vehicle typically operates for the majority of the time, the first evaporator 11 can be considered a regular evaporator. In contrast, the vehicle's stoppage time is shorter, making the electric heating device 15 operating time much shorter than that of the first evaporator 11. Since both the electric heating device 15 and the first evaporator 11 provide energy to the refrigerant, the electric heating device 15 can be understood as an auxiliary evaporator.

Of course, when the refrigerated vehicle starts or shortly after startup, the waste heat generated is insufficient to drive the expander 12. At this time, the electric heating device 15 can heat the refrigerant to ensure normal operation of the rankine cycle during the initial phase. Once sufficient waste heat is generated by the vehicle, the electric heating device 15 can be turned off. Since the time required for the refrigerated vehicle to generate sufficient waste heat is relatively short, the required operating time of the electric heating device 15 is also relatively short, preventing excessive electricity consumption.

Therefore, when the refrigerated vehicle starts, its waste heat is already being utilized by the rankine cycle, maximizing waste heat utilization and significantly reducing environmental pollution. The installation of the electric heating device 15 enables effective utilization of the initially limited waste heat, preventing waste.

In other embodiments, such as when the refrigerated vehicle's transportation time is relatively short, the rankine cycle can also be used for power generation to supply electricity to equipment on the refrigerated vehicle, thereby reducing energy consumption.

In conclusion, the rankine cycle system 1 of the present application, through the installation of an electric heating device 15 between the refrigerant pump 14 and expander 12, can continue to provide energy to the rankine cycle through the electric heating device 15 in the absence of a waste heat source, enabling the expander 12 to continuously and effectively output mechanical work. Even without a waste heat source, the rankine cycle can still operate normally, thus adapting to more operating conditions.

The above embodiments are only used to explain the technical solutions of the present application and are not limiting. Although the present application has been described in detail with reference to preferred embodiments, those skilled in the art should understand that modifications or equivalent substitutions can be made to the technical solutions of the present application without departing from the spirit and scope of the technical solutions of the present application.

What is claimed is:

1. A rankine cycle system, comprising a first evaporator, an expander, a condenser and a refrigerant pump connected in sequence to form a cycle, wherein the rankine cycle system further comprises at least two heating modes for providing heat to the first evaporator.

2. The rankine cycle system according to claim 1, wherein the heating modes comprise waste heat heating, electric heating, combustion heating, geothermal heating, or residual heat heating.

3. The rankine cycle system according to claim 1, wherein the rankine cycle system further comprises a heating device connected between the refrigerant pump and the expander for heating the refrigerant; wherein:
the heating device is an electromagnetic induction heating device comprising an electromagnetic heating controller and an electromagnetic induction coil connected to the electromagnetic heating controller, wherein the electromagnetic induction coil is fitted around an outer side of a pipeline between the first evaporator and the expander;
or, the heating device is a combustion heating device or a thermal radiation device.

4. The rankine cycle system according to claim 1, wherein the rankine cycle system further comprises a detection device disposed between the heating device and the expander for detecting temperature and/or pressure of the refrigerant.

5. The rankine cycle system according to claim 1, wherein the refrigerant pump is a variable-frequency refrigerant pump.

6. A rankine-refrigeration cycle system, comprising a refrigeration cycle system and the rankine cycle system according to claim 1, wherein the refrigeration cycle system comprises a compressor, a first heat exchanger, a throttling device and a second evaporator connected in sequence to form a cycle, and wherein the rankine-refrigeration cycle system further comprises a transmission assembly connecting the expander and the compressor.

7. The rankine-refrigeration cycle system according to claim 6, wherein the first heat exchanger comprises a first fluid passage and a second fluid passage, wherein the first fluid passage is connected between the compressor and the throttling device, and the second fluid passage is connected between the refrigerant pump and the first evaporator; wherein the rankine-refrigeration cycle system further comprises a second heat exchanger having a first fluid passage and a second fluid passage, wherein the first fluid passage is connected between the second evaporator and the compressor, and the second fluid passage is connected between the expander and the condenser.

8. The rankine-refrigeration cycle system according to claim 6, wherein the compressor has a first working state in which it is connected to the expander through the transmission assembly, and a second working state in which it is connected to an electric drive mechanism.

9. The rankine-refrigeration cycle system according to claim 8, wherein the transmission assembly comprises a main drive shaft connected to the expander and a secondary drive shaft connected to the compressor, wherein the main drive shaft and the secondary drive shaft are detachably connected; wherein the electric drive mechanism comprises a first clutch disposed on the secondary drive shaft, a drive motor cooperating with the first clutch, and a connecting structure connecting the first clutch and the drive motor.

10. The rankine-refrigeration cycle system according to claim 9, wherein the transmission assembly further comprises a connecting device for connecting the main drive shaft and the secondary drive shaft, wherein the connecting device comprises a coupling fixed to one of the main drive shaft and the secondary drive shaft, and a second clutch cooperating with and fixed to the coupling on the other shaft;
or, wherein the transmission assembly further comprises a connecting device for connecting the main drive shaft and the secondary drive shaft, wherein the connecting device comprises a coupling fixed to one of the main drive shaft and the secondary drive shaft, and a second clutch cooperating with and fixed to the coupling on the other shaft, wherein the connecting device comprises a first gear disposed on the main drive shaft and a second gear disposed on the secondary drive shaft and cooperating with the first gear, wherein the first gear and the second gear have different diameters;
or, wherein the transmission assembly further comprises a connecting device for connecting the main drive shaft and the secondary drive shaft, wherein the connecting device comprises a coupling fixed to one of the main drive shaft and the secondary drive shaft, and a second clutch cooperating with and fixed to the coupling on the other shaft, wherein the connecting device comprises a first gear disposed on the main drive shaft, a second clutch fixed to the first gear, and a second gear disposed on the secondary drive shaft and cooperating with the first gear, wherein the first gear and the second gear have different diameters, and wherein the first gear drives the main drive shaft to rotate through the second clutch.

11. The rankine-refrigeration cycle system according to claim 9, wherein the first clutch is an electrically-engaged clutch, and the second clutch is an electrically-disengaged clutch.

12. The rankine-refrigeration cycle system according to claim 12, wherein the electric drive mechanism further comprises a power supply module for supplying power to the first clutch, the second clutch and the drive motor.

13. The rankine-refrigeration cycle system according to claim 9, wherein the rankine-refrigeration cycle system further comprises a subcooling degree controller connected between the first heat exchanger and the throttling device.

14. A refrigerated vehicle comprising a refrigerated chamber, and further comprising the rankine-refrigeration cycle system according to claim 6, wherein the first evaporator of the rankine cycle system is thermally connected to a waste heat source of the refrigerated vehicle through a heat transfer assembly, and wherein the evaporator of the refrigeration system supplies cooling to the refrigerated chamber through a cooling assembly.

15. The rankine-refrigeration cycle system according to claim 14, wherein the refrigerated vehicle comprises an engine and a heat dissipation assembly for cooling the engine, wherein the heat transfer assembly connects the heat dissipation assembly and the first evaporator; or, wherein the refrigerated vehicle further comprises a cold storage unit for providing cooling capacity to the refrigerated chamber, wherein the second evaporator is thermally connected to the cold storage unit.
